(19) United States
(12) Patent Application Publication
(10) Pub. No.: US 2009/0267906 A1
(43) Pub. Date: Oct. 29, 2009

(54) Touch sensitive apparatus

(75) Inventor: Osmo Schroderus, Sumiainen (FI)

Correspondence Address: HARRINGTON & SMITH, PC, 4 RESEARCH DRIVE, Suite 202, SHELTON, CT, 06484-6212, US

(73) Assignee: Nokia Corporation

(21) Appl. No.: 12/150,275

(22) Filed: Apr. 25, 2008

(51) Int. Cl. G06F 3/041

(52) U.S. Cl. 345/173

(57) ABSTRACT

An apparatus includes a touch sensitive input panel operable to detect a location of a touch input and a pressure pad arranged to detect a force due to the touch input.

### FIELD OF THE INVENTION

The invention relates to a touch sensitive device.

### BACKGROUND

It is well known for mobile phones and other such devices to include touch sensitive panels.

### SUMMARY OF THE INVENTION

In a first aspect of the invention, an apparatus is provided, the apparatus comprising a touch sensitive input panel operable to detect a location of a touch input and a pressure pad arranged to detect a force due to the touch input.

The touch sensitive input panel may be transparent and the apparatus may further comprise a display panel, a display surface of the display panel being visible through the touch sensitive input panel.

The touch sensitive input panel may be a capacitive touch sensitive panel and the display panel may be an LCD panel.

The pressure pad may comprise a tube, the tube being connected to a pressure sensor for detecting pressure of gas within the tube.

A first end of the tube may be sealed and a second end of the tube may be in sealed connection with the pressure sensor.

Alternatively, the first end of the tube may be in sealed connection with a portion of the tube near to the second end, wherein said portion comprises an aperture and the first end is sealed around said aperture.

The tube may be arranged around a perimeter portion of the display panel.

The tube may comprise a soft elastomer.

The pressure sensor may be mounted on a printed circuit board.

The pressure sensor may be in communication with a processor and the processor may be arranged to determine the force due to the touch input based at least partly on the detected pressure.

The processor may be arranged to register the touch input if the detected force exceeds a predetermined threshold.

The touch sensitive panel may be in communication with the processor and the processor may be arranged to determine a location of the touch input.

The processor may be arranged to register the touch input if the detected force exceeds a predetermined threshold, and the location of the touch input corresponds to an option displayed on the display surface.

The pressure pad may be interposed between the touch sensitive input panel and the display panel.

The tube may be arranged around a perimeter portion of the display surface and the pressure pad may further comprise first and second extension members, the first extension member extending from the tube in a direction perpendicular to the display surface and the second extension member extending from an end of the first extension member in a direction parallel to the display panel surface, the tube and the first and second extension members forming a recess parallel to the display surface, and an edge of the touch sensitive panel may be provided within the recess.

Alternatively, the display panel may be interposed between the touch sensitive panel and the pressure pad. A gasket may be interposed between the display panel and the touch sensitive panel.

According to a second aspect of the invention, a method is provided, the method comprising detecting a force of a received touch input, determining if the force is greater than a predetermined threshold, and, if the force is greater than a predetermined threshold, registering the input.

Detecting the force may comprise detecting a pressure change of gas within a pressure pad, the pressure change being due to the received touch input. The pressure change may be due to compression of the pressure pad due to the received touch input.

The method may further comprise determining a location of the touch input, determining if the location of the touch input corresponds to a selectable option, and, only if the location of the touch input corresponds to a selectable option and the force is greater than a predetermined threshold, registering the input.

Registering the input may comprise altering a display based at least partly on the selectable option.

Determining if the force is greater than a predetermined threshold may comprise determining if the force is greater than one or more predetermined thresholds, whereby registering the input may comprise altering a display also based at least partly on which of the one or more predetermined thresholds the force exceeds.

According to a third aspect of the invention, a method is provided, the method comprising providing a display panel, a touch sensitive panel, and a tube, a first end of the tube being sealed and a second end being open, fixing the tube to display panel, fixing the touch sensitive panel to the tube or the display panel, and attaching, in a sealed connection, a pressure sensor to the second end of the tube.

Fixing the tube to the display panel may comprise fixing a first outer surface of the tube to a display surface of the display panel, and fixing the touch sensitive panel may comprise fixing the touch sensitive panel to a second outer surface of the tube, the second outer surface being opposite the first outer surface.

Alternatively, fixing the tube to the display panel may comprise fixing the tube to a surface opposite a display surface of the display panel, and fixing the touch sensitive panel may comprise fixing the touch sensitive panel to the display surface of the display panel.

### BRIEF DESCRIPTION OF THE DRAWINGS

FIG. 1 shows a mobile phone terminal in which the invention can be embodied;

FIG. 2A shows an expanded view of a first embodiment of the invention;

FIG. 2B shows an unexpanded view of the first embodiment;

FIG. 2C show the first embodiment undergoing a touch input;

FIG. 3 shows a plan view of an end portion of the first embodiment;

FIG. 4 shows an alternative embodiment of the invention;

FIG. 5 shows a second alternative embodiment of the invention;

FIG. 6A shows a third alternative embodiment of the invention;

FIG. 6B shows a cross-sectional view of the third alternative embodiment of the invention;

FIG. 7 shows a schematic of circuitry utilised in the operation of any of the embodiments of the invention;

FIG. 8 shows a flow diagram depicting the operation of any of the embodiments of the invention;

FIG. 9 shows a flow diagram depicting a method of manufacture of any of the embodiments of the invention;

### DETAILED DESCRIPTION OF THE EMBODIMENTS

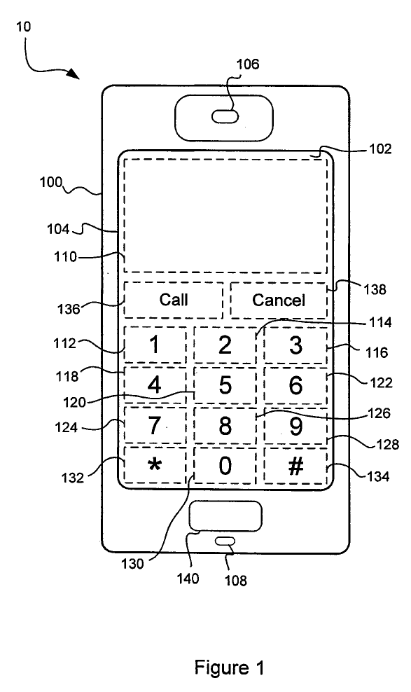

FIG. 1 shows a mobile phone terminal 10 having a cover 100 and a touch sensitive display 102, a visible region of the touch sensitive display 102 being defined by a window 104 formed in the cover 100. The phone 10 also has a speaker 106 and a microphone 108. Displayed on the touch sensitive display 102 are an input display 110, ten numeral keys (0 to 9) 112, 114, 116, 118, 120, 122, 124, 126, 128, 130, a star key 132, a hash key 134, a call key 136, and a cancel key 138. The mobile phone terminal also has a physical key 140. It should be understood that the mobile phone alternatively may not include a physical key or may have more than one physical key. The physical key 140 could have any number of different functions, one of which might be, for example, closing down an application currently being viewed.

A user can select a number or option by providing a touch input to a region of the touch sensitive display on which the number or option is displayed. The touch input can be provided by, for example, the user's finger or a stylus.

While the embodiment shown in FIG. 1 is a mobile phone terminal 10, it should be understood that the invention also applies to other devices such as communicators, PDA devices, multimedia computers, and portable multimedia players.

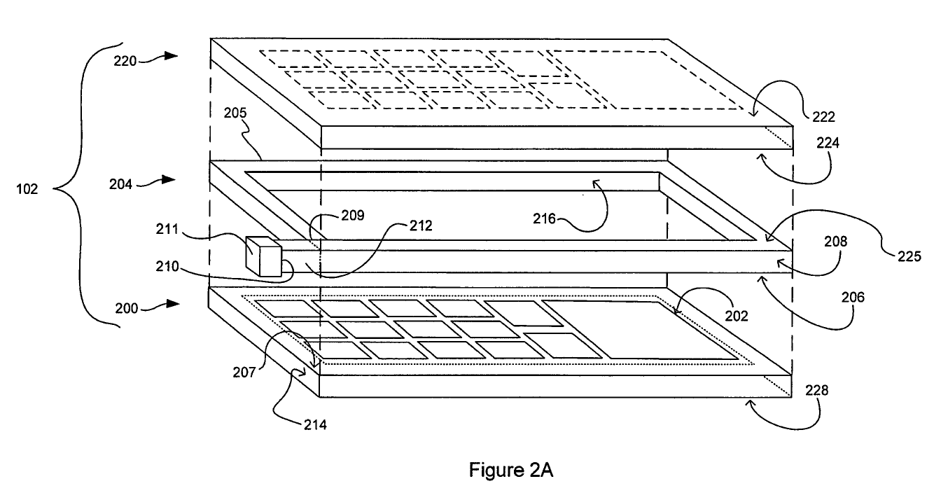

FIGS. 2A and 2B are, respectively, expanded and unexpanded three-dimensional schematics of the touch sensitive display 102 of the mobile phone terminal 10. The touch sensitive display 102 comprises a display panel 200, having a rectangular shaped display surface 202 (although other shapes, for example a square, may also be suitable). The display panel 200 may be an LCD display screen, the operation and construction of which are well known in the art. It should be understood, however, that other suitable types of display panel may be used instead. Displayed by the display panel are the input display 110, the ten numeral keys 112, 114, 116, 118, 120, 122, 124, 126, 128, 130, the star key 132, the hash key 134, the call key 136, and the cancel key 138.

The touch sensitive display further comprises a pressure pad 204, the pressure pad being contacted to the display surface 202 of the display panel 200. The pressure pad 204 comprises a tube 205, having a square cross section. The dimensions of the cross section of the tube may be approximately 1 mm×1 mm. It should be understood that various other cross-sectional shapes may also be suitable. Such suitable shapes include, but are not limited to, rectangular, circular, double concave (i.e. generally rectangular but with two opposing concave sides), or double convex (i.e. generally rectangular but with two opposing convex sides). It should also be understood that alternative dimensions may also be suitable. The tube 205 is arranged such that a first outer surface 206 of the tube 205 is contacted to a perimeter portion 207 of the display surface 202. The perimeter portion 207 of the display surface 202 is a portion of the display surface in which images ate not displayed. Due to the display surface 202 being rectangular and the tube 205 being in contact with a perimeter portion 207 of the display surface 202, the tube 205 forms a generally rectangular shape, with a second outer surface 208 of the tube 205 being generally aligned with the perimeter of the display surface 202. A first end 209 of the tube 205 is sealed and a second end 210 is in sealed connection with a pressure sensor 211. An end portion 212 of the tube 205, immediately preceding the second end 210 of the tube 205, extends beyond an edge 214 of the display surface 202. Alternatively the second end 210 of the tube 205 may be aligned with the edge 214 of the display surface 202. The first end 209 of the tube 205 adjoins a portion of a third outer surface 216 of the tube 205, the portion being in adjacent to the edge 214 of the display surface 202.

Alternatively, the first end 209 of the tube 205 may be in sealed connection with the portion of the third outer surface 216 of the tube 205 adjacent to the edge 214 of the display surface 202. The pressure sensor 211 is in sealed connection with the second end 210 of the tube 205. The portion of the third outer surface 216 of the tube 205 adjacent to the edge 214 of the display surface 202 may comprise an aperture around which the first end 209 of the tube 205 is sealed. The tube thus formed is a continuous tube with an extension thereof attached to the pressure sensor 211.

The pressure sensor 211 is arranged to detect the pressure of air within the tube 205. The tube 205 may be constructed of a soft elastomer, for example silicone, and may have a wall thickness of approximately 0.3 mm. Again, it should be understood that different wall thicknesses and materials may also be suitable.

The touch sensitive display 102 further comprises a touch sensitive panel 220. The touch sensitive panel 220 has a first surface 222, being a touch sensitive surface arranged to receive a touch input, and, opposite the first surface 222, a second surface 224. The first and second surfaces 222, 224 of the touch sensitive panel 220 have generally the same dimensions as the display surface 202 of the display panel 200 and the touch sensitive panel 220 is generally aligned with the pressure pad 204 and the display panel 200. The second surface 224 of the touch sensitive panel 220 is contacted to a fourth outer surface 225 of the tube 205, such that the pressure pad 204 is interposed between the display panel 200 and the touch sensitive panel 220. This can be seen clearly in FIG. 2B. The touch sensitive panel 220 is constructed of transparent material. The touch sensitive panel 220 may be a capacitive touch sensitive panel, the operation and construction of which is well known in the art. Other types of touch sensitive panel may also be appropriate.

Due to the transparency of the touch sensitive panel 220, an image displayed by the display panel 200 is visible through the touch sensitive panel 220. Therefore, when a user desires to select a key, a touch input is provided to a region of the touch sensitive surface 222 corresponding to a region of the display surface 202 on which the desired key is displayed. This can be seen in FIG. 2C, in which the user wishes to select the “6” key 122. Due to the touch input, a force (denoted by the arrow F) is exerted on the touch sensitive panel 220 in a direction generally perpendicular to touch sensitive surface 222. This force is transferred through the touch sensitive panel 220 onto pressure pad 204, which causes the tube 205 to compress. This compression of the tube 205 causes an interior volume of tube 205 to decrease, which in turn results in a change (an increase) in the pressure of the air within the tube 205. This pressure change is detected by the pressure sensor 211.

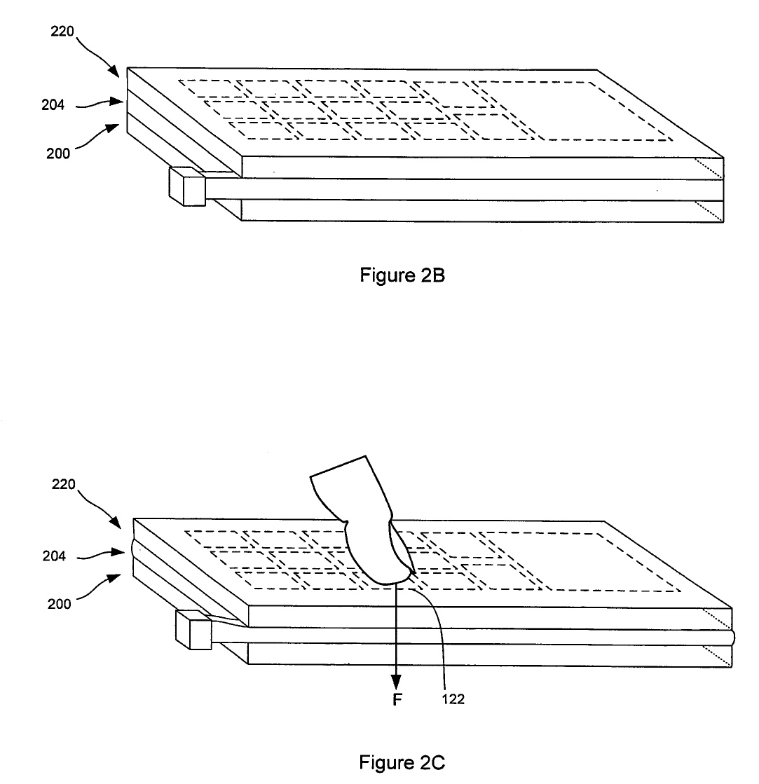

FIG. 3 is a plan view of an end portion of the touch sensitive display 102. The touch sensitive panel 220, the end portion 212 of the tube 205 and the pressure sensor 211 underlie the cover 100. The pressure sensor 211 is a surface mounted device (SMD) and is mounted on a printed circuit board (PCB) 226. SMD pressure sensors are currently available in sizes of approximately 6 mm×6 mm×3 mm. Other internal components can also be mounted on the PCB 226, for example a main processor (not shown) and a memory (not shown). Visible through the touch sensitive panel 220 are various keys 118, 120, 122, 124, 126, 128, 130, 132, 134 being displayed by underlying display panel (not visible).

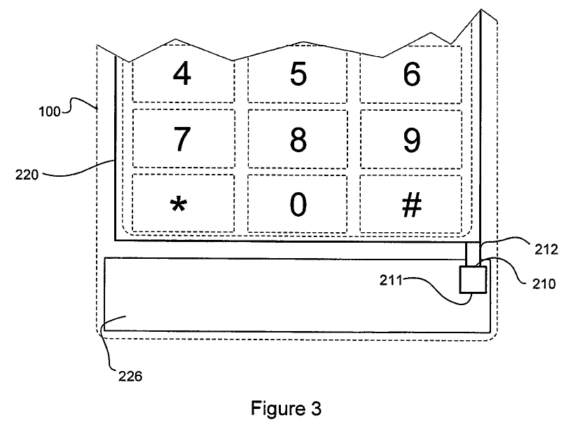

FIG. 4 shows a first alternative embodiment of the touch sensitive display 102. In this embodiment, the display surface 202 of the display panel 200 is aligned with, and contacted to, the second surface 224 of the touch sensitive panel 202, while the fourth outer surface 225 of the tube 205 is contacted to perimeter portion (not visible) of a second surface 228, opposite to the display surface 202, of the display panel 200. Therefore, the display panel 200 is interposed between the pressure pad 204 and the touch sensitive panel 220.

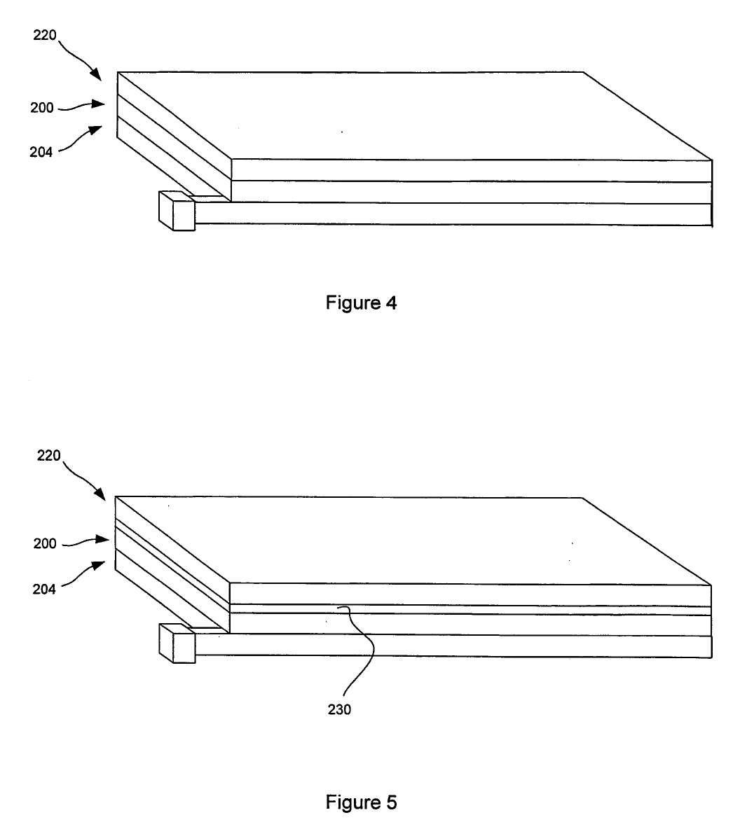

FIG. 5 shows a second alternative embodiment of the touch sensitive display 102. This embodiment is of the same construction as the embodiment of FIG. 4, but includes a display gasket 230 interposed between the display panel 200 and the touch sensitive panel 220.

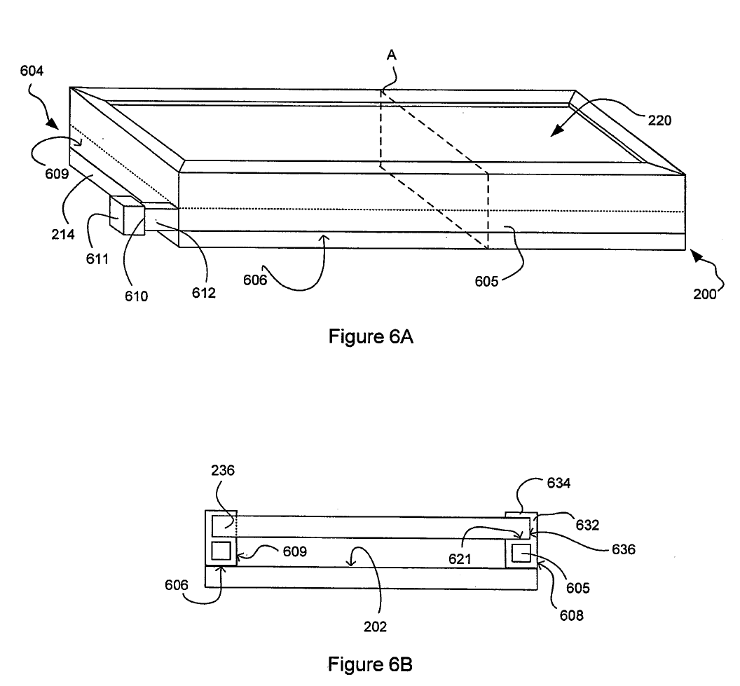

FIG. 6A and 6B, respectively, show three-dimensional and cross-sectional views of a third alternative embodiment of the touch sensitive display 102. FIG. 6B is a view of a cross-section of the touch sensitive display labelled A in FIG. 6A. This embodiment comprises the display panel 200, the touch sensitive panel 220 and a pressure pad 604. In this embodiment, the pressure pad 604 comprises a tube 605 having a generally square cross section (as can be seen in FIG. 6B).

A first outer surface 606 of the tube 605 is in contact with a perimeter portion 207 of the display surface 202 of the display panel 200. Subsequently, the tube 605 forms a rectangular shape, with a second outer surface 609 of the tube 605 being aligned the perimeter of the display surface 202. The tube 605 further comprises a first extension member 632 extending from and parallel to a second outer surface 608 of the tube 605The tube also further comprises a second extension member 634 extending at right angles from the first extension member 632 and aligned with the fourth outer surface 621 of the tube 605. The fourth outer surface 621 of the tube 605, the first extension member 632 and the second extension member 634 form a recess, the recess being parallel to the display surface 202.

A first end (not visible) of the tube 605 is sealed and a second end 610 is in sealed connection with a pressure sensor 611. The pressure sensor 611 may be the same as that described with reference to the first and other alternative embodiments. An end portion 612 immediately preceding the second end 610 of the tube 605 extends beyond an edge 214 of the display surface 202. Alternatively the second end 610 of the tube 605 may be aligned with the edge 214 of the display surface 202. The first end of the tube 605 adjoins a portion of a third outer surface 609 of the tube 605, the portion being in adjacent to the edge 214 of the display surface 202.

A perimeter portion 236 of the touch sensitive panel 220 sits within the recess formed by the fourth outer surface 621 of the tube 605, the first extension member 632 and the second extension member 634, such that the first extension member 632 surrounds all perimeter surfaces 636 of the touch sensitive panel 220.

As with the other embodiments, the tube may comprise a soft elastomer, such as silicone, and may have a wall thickness of 0.3mm and the square cross section may have dimensions of approximately 1 mm×1 mm. As mentioned previously, it should be understood that different materials, cross-sectional shapes, cross-sectional dimensions and wall thicknesses may also be suitable.

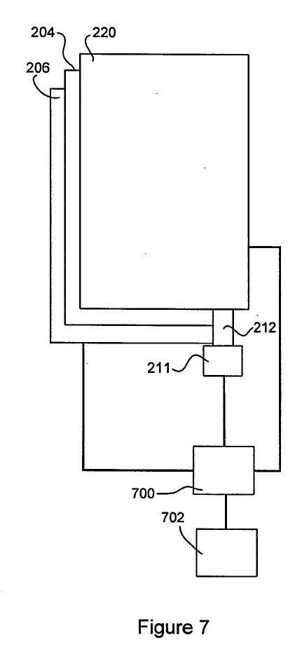

FIG. 7 shows an exemplary configuration of circuitry associated with the touch sensitive display 102. An output of the touch sensitive panel 220 is connected to a first input of a main processor 700, and an output of the pressure sensor 211 is connected to a second input of the main processor 700. In two-way connection with the main processor 700 is a memory 702, and connected to an output of the main processor 700 is an input of the display panel 200. Software programs for execution by the main processor are stored on the memory 702. It should be understood that, although the pressure pad 205 is shown in FIG. 7 as interposed between the display panel 200 and the touch sensitive display 220, the associated circuitry may be the same if, for example, the touch sensitive display is arranged as seen in FIGS. 4 and 5.

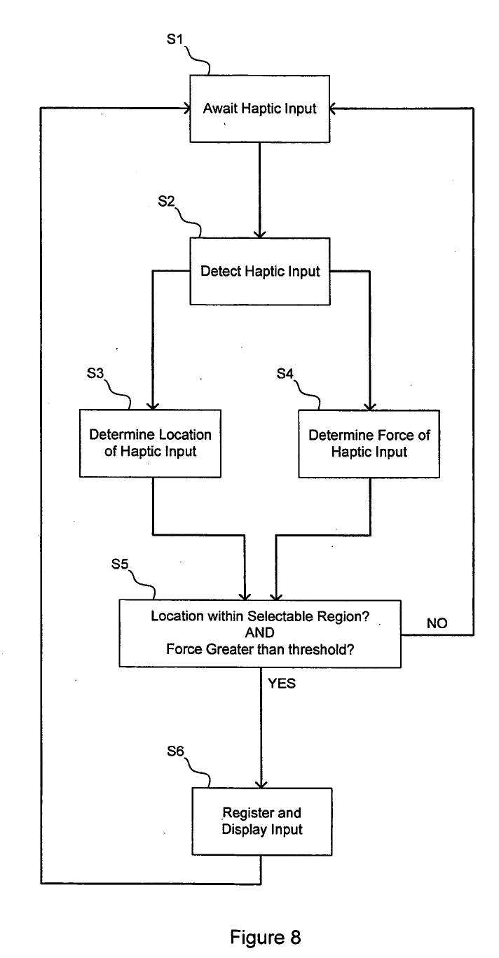

The operation of the touch sensitive display 102 and its associated circuitry will now be described with reference to FIG. 8. Depending on a user selected mode, for example a dial mode, the main processor 700 outputs signals to the display panel 200 instructing the display panel to display a particular image. As described above with reference to FIG. 1, the image may comprise a representation of a key pad, consisting of a plurality of keys 112, 114, 116, 118, 120, 122, 124, 126, 128, 130, 132, 134, 136, 138, and also an input display 110. At this point, the touch sensitive display 102 awaits a touch input S1. When a touch input is received S2 at the touch sensitive panel 220, a signal is generated by the touch sensitive panel 220 and is transmitted to the processor 700. The processor 700 then executes a first program stored on the memory 702 to determine S3, based at least partly on the signal received from the touch sensitive panel 220, the location of the touch input on the touch sensitive panel 220.

The force provided by the touch input results in the compression of the tube 205. As discussed, the compression of the tube 205 results in an increase in the pressure of the air within the tube. This increase is detected by the pressure sensor 211 and is communicated to the processor 700 via an electric signal. Having received this electric signal, the processor 700 executes a second program stored on the memory 702 to determine S4, based at least partly on the pressure increase of the air within the tube 205, the force exerted on the touch sensitive panel 220 due to the touch input.

In the next step S5, the processor 700 executes a third program stored on the memory 702 to determine if the location of the touch input on the touch sensitive panel 220 corresponds to a region of the display panel 200 on which a key is being displayed. The processor 700 also executes a fourth program stored on the memory 702 to determine if the force determined in the previous step S4 is greater than a predetermined threshold. The predetermined threshold may be, but certainly not limited to, a value between 1N and 5N and may be defined by a manufacturer or may be user-defined. If either one of the conditions (i.e. the location of the touch input corresponding to a region of the display panel 200 on which a key is being displayed, and the calculated force exceeding a predetermined threshold) is not met, then no input is registered by the processor 700 and the processor 700 returns to awaiting a touch input. If, however, both conditions are satisfied, the processor 700 instructs the display panel 200 to display on the input display 110 a numeral or symbol corresponding to the selected key. For example, if a user provides a touch input, having sufficient force, to a location on the touch sensitive panel corresponding to the region 122 of the display panel 200 on which “6” is displayed, the processor 700 will instruct the display panel 200 to display a “6” in the input display region 110 of the display panel. Following a registered input, the processor 700 returns to awaiting a touch input.

There may, alternatively, be more than one predetermined threshold, whereby a selected key has a different function depending on the threshold exceeded. For example, if a touch input, having a force greater that a first threshold (for example 2N) but less than a second threshold (for example 5N), is detected in a location on the touch sensitive panel corresponding to the region 122 of the display panel 200 on which “6” is displayed, the processor 700 may instruct the display panel 200 to display a “6” in the input display region 110 of the display panel. However, if a touch input, having a force greater than the second threshold, is detected in the same location, the processor 700 may instruct the display panel to display, for example, a predefined “quick dial” telephone number corresponding to the selected region of the display screen (for example stored in a sixth “quick dial” slot).

The method of operation has been described with reference to dialling a telephone number on a mobile telephone. In this situation, it is necessary for the apparatus to determine if the location of the touch input. It should be understood, however, that there may be some situations in which the location of the touch input is not important. This may occur, for example, if a user is watching a video and they wish to bring up a menu. In this situation the user may provide a touch input to anywhere on the display screen. Therefore, in this case, the method of operation may not include the determination of the location of the touch input, or the determination of whether location corresponds to a selectable option.

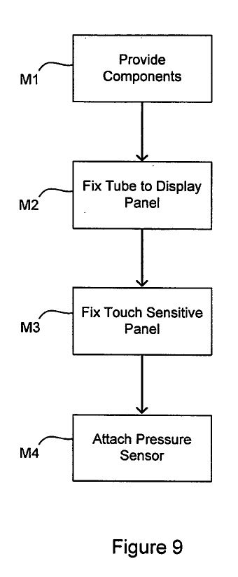

A method of assembly of the embodiments of the touch sensitive display 102 will now be described with reference to FIG. 9.

At the first step M1, the touch sensitive panel 220, the display panel 200 and the tube 205; 605 are provided. The first end 209 of the tube 205 is sealed and the second end 210; 610 is open. At the second step M2, the tube 205; 605 is fixed to the display panel 200. Depending on the embodiment under manufacture, the first outer surface 206 of the tube 205, 605 may be fixed to the perimeter portion 207 of the display surface 202 (as in the embodiments of FIGS. 2 and 6) or alternatively the third outer surface 221; 621 of the tube 205; 605 may be fixed to a perimeter portion of the second surface 228 of the display panel 200 (as in the embodiments of FIGS. 4 and 5). In the next step M3, the touch sensitive panel 220 is fixed. Again, depending on the embodiment under manufacture, the position in which the touch sensitive panel 220 is fixed may vary. The second surface 224 of the touch sensitive panel 220 may be fixed to the third surface 221; 621 of the tube 205; 605 (as in the embodiments of FIGS. 2 and 6). Alternatively, the second surface 224 of the touch sensitive panel 220 may be fixed to the display surface 202 of the display panel 200, either directly (as in the embodiment of FIG. 4) or via a display gasket 230 (as in the embodiment of FIG. 5). Finally, when the display panel 200, the tube 205; 605 and the touch sensitive panel 220 are correctly positioned, the pressure sensor 211; 611 is attached M4 in a sealed connection with the second end of the tube 210; 610.

After the touch sensitive display 102 has been assembled, the pressure sensor 211 can be connected to the processor 700. At this point, the processor 700 can be instructed to execute a tare program, stored on the memory 702. The tare program causes the processor to register a reference pressure value (either by storing the reference pressure value on the memory 702 or in another way). The reference pressure value is a pressure value detected by the pressure sensor 211 when no touch input is provided to the touch sensitive display 102. This reference pressure value will then be utilised by the processor 700 during execution of the second program to determine the force due to a touch input.

However, due to changes in device temperature, ambient temperature and air pressure, the pressure detected by the pressure sensor 211, when no touch input is being provided, may vary. Therefore, in order to negate any potential problems caused by this, the processor 700 can be programmed to execute the tare program, thereby resetting the reference pressure value, on a regular basis. The regularity of the execution of the tare program may be defined by the manufacturer or may be defined by the user.

The described embodiments provide a number of advantages. A first of these is that the touch sensitive display imitates a normal keypad in that, in order for an input to be registered, a sufficient force must be applied. This means that, in order for a user to select an option displayed on the screen, a deliberate pressing action is required and, therefore, the chance of erroneous inputs due to erroneous touch inputs (that may happen, for example, when the mobile phone terminal is in the user's pocket or bag) is reduced.

A second advantage is that the provision of the pressure pad in the touch sensitive display increases the tolerance of the display (and the device in which it is included) to components having dimensional variances. This is because, due to its soft elastomeric nature, the tube can compress, its shape adapting to compensate for the dimensional variances. Furthermore, as the pressure sensor is not attached, and therefore the tube is not sealed, until after the other components have been assembled, these dimensional variances do not affect the pressure of the air within the tube. Therefore, prior to a touch input, the pressure sensor will detect the same pressure (approximately 1 atm.) regardless of any dimensional variances.

It should be realised that the foregoing embodiments should not be construed as limiting. Other variations and modifications will be apparent to persons skilled in the art upon reading the present application. Moreover, the disclosure of the present application should be understood to include any novel features or any novel combination of features either explicitly or implicitly disclosed herein or any generalisation thereof and during the prosecution of the present application or of any application derived therefrom, new claims may be formulated to cover any such features and/or combination of such features.

1. An apparatus comprising a touch sensitive input panel operable to detect a location of a touch input and a pressure pad arranged to detect a force due to the touch input.

2. An apparatus according to claim 1, wherein the touch sensitive input panel is transparent and the apparatus further comprises a display panel, a display surface of the display panel being visible through the touch sensitive input panel.

3. An apparatus according to claim 2, wherein the pressure pad comprises a tube, the tube being connected to a pressure sensor for detecting pressure of gas within the tube.

4. An apparatus according to claim 3, wherein the pressure sensor is in communication with a processor, the processor being arranged to determine the force due to the touch input based at least partly on the detected pressure.

5. An apparatus according to claim 4, wherein the processor is arranged to register the touch input if the detected force exceeds a predetermined threshold.

6. An apparatus according to claim 4, wherein the touch sensitive panel is in communication with the processor and the processor is arranged to determine a location of the touch input.

7. An apparatus according to claim 6, wherein the processor is arranged to register the touch input if the detected force exceeds a predetermined threshold and the location of the touch input corresponds to an option displayed on the display surface.

8. An apparatus according to claim 2, wherein the pressure pad is interposed between the touch sensitive input panel and the display panel.

9. An apparatus according to claim 2, wherein the display panel is interposed between the touch sensitive panel and the pressure pad.

10. An apparatus according to claim 3, wherein the tube is arranged around a perimeter portion of the display panel.

11. An apparatus according to claim 10, wherein:
the tube is arranged around a perimeter portion of the display surface;
the pressure pad further comprises first and second extension members, the first extension member extending from the tube in a direction perpendicular to the display surface and the second extension member extending from an end of the first extension member in a direction parallel to the display panel surface, the tube and the first and second extension members forming a recess parallel to the display surface; and
an edge of the touch sensitive panel is provided within the recess.

12. An apparatus according to claim 3, wherein the tube comprises a soft elastomer.

13. A method comprising:
detecting a force of a received touch input;
determining if the force is greater than a predetermined threshold; and
if the force is greater than a predetermined threshold, registering the input.

14. A method according to claim 13, wherein detecting the force comprises detecting a pressure change of gas within a pressure pad, the pressure change being due to the received touch input.

15. A method according to claim 13, further comprising:
determining a location of the touch input;
determining if the location of the touch input corresponds to a selectable option; and
only if the location of the touch input corresponds to a selectable option and the force is greater than a predetermined threshold, registering the input.

16. A method according to claim 15, wherein registering the input comprises altering a display based at least partly on the selectable option.

17. A method according to claim 13, wherein determining if the force is greater than a predetermined threshold comprises determining if the force is greater than one or more predetermined thresholds.

18. A method according to claim 17, wherein registering the input comprises altering a display based at least partly on which of the one or more predetermined thresholds the force exceeds.

19. Machine-readable instructions which when executed by computer apparatus control it to perform the method of claim 13.

20. Computer-readable media having stored thereon machine readable instructions which when executed by computer apparatus control it to perform the method of claim 13.

21. A method comprising:
providing a display panel, a touch sensitive panel, and a tube, a first end of the tube being sealed and a second end being open;
fixing the tube to display panel;
fixing the touch sensitive panel to the tube or the display panel;
attaching, in a sealed connection, a pressure sensor to the second end of the tube.

22. A method according to claim 21, wherein fixing the tube to the display panel comprises fixing a first outer surface of the tube to a display surface of the display panel.

23. A method according to claim 22, wherein fixing the touch sensitive panel comprises fixing the touch sensitive panel to a second outer surface of the tube, the second outer surface being opposite the first outer surface.

24. A method according to claim 21, wherein fixing the tube to the display panel comprises fixing the tube to a surface opposite a display surface of the display panel.

25. A method according to claim 24 wherein fixing the touch sensitive panel comprises fixing the touch sensitive panel to the display surface of the display panel.
